(19) United States
(12) Patent Application Publication
(10) Pub. No.: US 2012/0297662 A1
(43) Pub. Date: Nov. 29, 2012

(54) STINK BUG TRAP

(76) Inventor: Andrew Paul Strube, Columbia, PA (US)

(21) Appl. No.: 13/299,980

(22) Filed: Nov. 18, 2011

Related U.S. Application Data
(60) Provisional application No. 61/436,777, filed on Jan. 27, 2011.
(60) Provisional application No. 61/415,089, filed on Nov. 18, 2010.

(51) Int. Cl. A01M 1/04; A01M 1/14

(52) U.S. Cl. 43/113; 43/114

(57) ABSTRACT

A stink bug trap constructed in accordance with an embodiment includes a first housing, and a support member that extends from the first housing along a first direction. The support member includes a body, a channel extending at least partially through the body along the first direction, and at least one aperture that extends through the body along a direction that is transverse to the first direction. The stink bug trap further includes a fluorescent light source and a removable cartridge. The fluorescent light source is coupled to the first housing such that the light source extends into the channel of the support member. The removable cartridge is configured to be mounted on the support member. The removable cartridge has a sticky surface that is configured to immobilize a stink bug.

### CROSS REFERENCE TO RELATED APPLICATIONS

This application claims the benefit of U.S. Provisional Application Ser. No. 61/415,089 filed Nov. 18, 2010, and U.S. Provisional Application Ser. No. 61/436,777 filed Jan. 27, 2011, the disclosures of which are hereby incorporated by reference as set forth in their entirety herein.

### BACKGROUND

Stink bugs, which belong to a super family of insects known as pentatomidea, can be pests in a home or other building that is located within an infested area. Stink bugs will enter such buildings through cracks around windows, doors, siding, utility pipes, and other openings into the buildings.

Exterior applications of insecticides have been used and may offer some minor relief from infestations where the task of completely sealing the exterior is difficult or impossible. Unfortunately, because insecticides are broken down by sunlight, the residual effect of the material will be greatly decreased and may not kill the insects much beyond several days or a week.

Additionally, some nontoxic methods have been used to control stink bugs. For example, stink bugs are attracted to the color yellow, and yellow sticky traps for trapping stink bugs have been used. Such traps will often times be impregnated with a pheromone to lure the stink bugs to the traps, and once they land on the sticky portion of the trap, the stink bugs will be trapped and then subsequently disposed of.

While various traps and insecticides have been used to control stink bug infestations in and around homes and other buildings, there remains a need for improved traps and methods for controlling the problem.

### SUMMARY

In accordance with an embodiment, a stink bug trap can include a first housing and a support member that supports the first housing and extends from the first housing along a first direction. The support member includes a body and a channel that extends at least partially through the body along the first direction. The stink bug trap also includes a fluorescent light source coupled to the first housing such that the fluorescent light source directs fluorescent light into the channel of the support member so as to attract sink bugs toward the support member. The stink bug trap also includes a replaceable cartridge that is configured to be removeably disposed about at least a portion of the support member such that the support member is disposed between the directed fluorescent light and the cartridge. The replaceable cartridge includes a cartridge body that defines an inner surface that faces the support member and a sticky outer surface opposite the inner surface. The cartridge body is at least translucent so as to transmit at least a portion of the directed light from the inner surface through the sticky outer surface, and the sticky outer surface is configured to adhere to a stink bug when the stink bug is brought into contact with the sticky surface, thereby immobilizing the stink bug.

In accordance with another embodiment, a replaceable cartridge that is configured to be placed on a cylindrical rigid support member of a stink bug trap between first and second housings so as to be captured between the first and second housings is disclosed. The replaceable cartridge includes a cylindrical translucent body that is elongate in a first direction. The body includes an inner surface that faces the support member when the replaceable cartridge is placed on the support member, and a sticky outer surface opposite the inner surface. The inner surface defines a channel that extends through the body along the first direction, and the sticky outer surface is configured to adhere to a stink bug when the stink bug is brought into contact with the sticky surface, thereby immobilizing the stink bug. At least a portion of the body is configured to be mounted on the rigid support member of the stink bug trap such that the channel at least partially receives a fluorescent light bulb and light produced by the fluorescent light bulb is visible through the body to thereby attract stink bugs to the outer sticky surface of the body.

A method of immobilizing stink bugs in accordance with an embodiment includes the step of mounting a removable cartridge onto a rigid member. The removable cartridge defines a sticky surface that is configured to immobilize stink bugs. Stink bugs are lured to the removable cartridge with a fluorescent light bulb. The stink bugs are immobilized once the stink bugs contact the sticky surface of the removable cartridge. The removable cartridge may be removed from the rigid member after the removable cartridge has immobilized a plurality of stink bugs.

### BRIEF DESCRIPTION OF THE DRAWINGS

The foregoing summary, as well as the following detailed description of exemplary embodiments, will be better understood when read in conjunction with the appended drawings, in which there is shown in the drawings example embodiments for the purposes of illustration. It should be understood, however, that the application is not limited to the precise arrangements and systems shown, in the drawings:

FIG. 1A is a perspective view of a stink bug trap constructed in accordance with an embodiment, the stink bug trap being configured to hang from a structure;

FIG. 1B is an exploded perspective view of the stink bug trap shown in FIG. 1A, the stink bug trap including a first housing, a second housing, a rigid support member extending between the first and second housings and having a plurality of apertures, a fluorescent light source coupled to the first housing and configured to be disposed within the support member, and a cartridge slidable over the support member;

FIG. 2 is a bottom plan view of the support member shown in FIG. 1B;

FIG. 3 is a bottom plan view of the first housing shown in FIG. 1B;

FIG. 4 is a top plan view of the second housing shown in FIG. 1B;

FIG. 5A is a perspective view of the cartridge shown in FIG. 1B, the cartridge having a sticky outer surface that is configured to adhere to stink bug so as to immobilize the stink bugs;

FIG. 5B is a bottom view of the replaceable cartridge shown in FIG. 5A;

FIG. 6A is a perspective view of a stink bug trap constructed in accordance with another embodiment, the stink bug trap having a base and being configured to be supported on a structure;

FIG. 6B is an exploded perspective view of the stink bug trap shown in FIG. 5A, the stink bug trap including a first housing, a second housing, a rigid support member extending between the first and second housings and having a plurality of apertures, a fluorescent light source coupled to the first housing and configured to be disposed within the support member, a cartridge slidable over the support member, and a base extending from the first housing; and

FIG. 7 is a perspective view of a stink bug trap constructed in accordance with another embodiment, the stink bug trap having a solar panel configured to power the stink bug trap.

### DETAILED DESCRIPTION

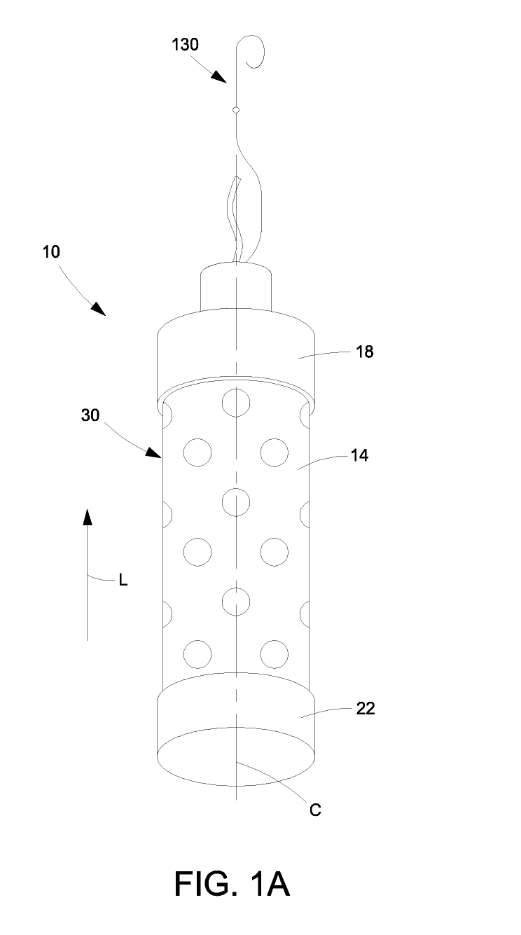

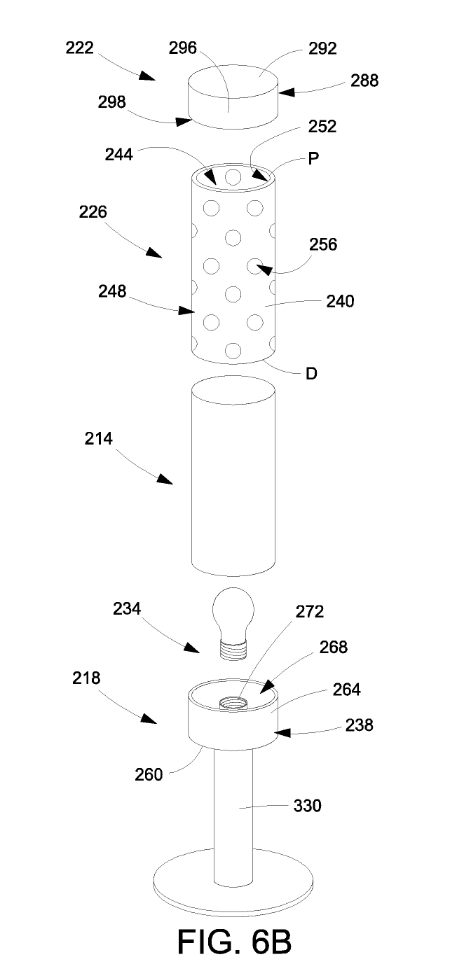

Referring to FIGS. 1A and 1B, a stink bug trap 10 is configured to be positioned in an area that is infested with stink bugs such as inside a building or outside of a building to thereby eliminate the stinks bugs from the infested area. The stink bug trap 10 can be configured as a hanging trap as shown in FIG. 1A or as a tabletop trap as shown in FIG. 6A. Now referring to FIG. 1B, the stink bug trap 10 includes a replaceable cartridge 14 that is configured to adhere to the stink bugs so as to immobilize the stink bugs once the stink bugs come into contact with the replaceable cartridge 14. When the replaceable cartridge 14 is full, the replaceable cartridge 14 may be removed and subsequently replaced with a new replaceable cartridge 14.

As shown in FIGS. 1A and 1B, the stink bug trap 10 includes a first housing 18, a second housing 22, and a substantially rigid support member 26 that extends between the first and second housings 18 and 22 along a first direction L and defines a central axis C. The first housing 18, the second housing 22, and the support member 26 together define a mount 30 that is configured to support the replaceable cartridge 14. The stink bug trap 10 further includes a fluorescent light source 34, such as a fluorescent light bulb, that is configured to attract or otherwise lure the stink bugs to the stink bug trap 10 and in particular to the replaceable cartridge 14. In some embodiments, at least one of the first housing 18, the second, housing 22, the support member 26, and the replaceable cartridge 14 can include a stink bug attractant such as a pheromone.

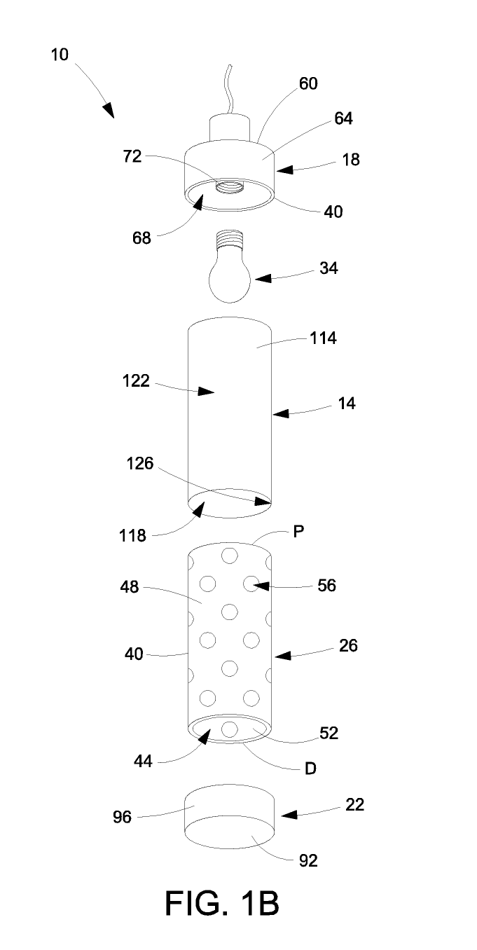

As shown in FIGS. 1B and 2, the support member 26 includes a body 40 that is elongate in the first direction L and defines a proximal end P and a distal end D. The support member 26 further includes a cylindrical channel 44 that extends at least partially through the body 40 along the first direction L. In the illustrated embodiment, the channel 44 extends completely through the body 40, though it should be appreciated that the channel 44 can extend only partially through the body 40, as desired. Moreover, the channel 44 can have any shape as desired and is not limited to a cylindrical shape as illustrated. The support member 26 can be made from any material as desired. For example, the support member 26 can be made from a plastic material. Moreover, the support member 26 can be at least translucent so as to allow light from the fluorescent light source 34 to pass through the body 40. It should be appreciated however, that the support member 26 can also be opaque so long as the body 40 includes some structure that allows light from the fluorescent light source 34 to pass through the body 40.

The body 40 has an outer surface 48 and an inner surface 52. The support member 26 includes at least one, such as a plurality of apertures 56 that extend through the body 40 from the outer surface 48 to the inner surface 52. The apertures 56 each extends through the body 40 along a direction that is transverse to the first direction L. In the illustrated embodiment, the apertures 56 each extend through the body 40 along a direction that is perpendicular to the first direction L, though it should be appreciated that the apertures 56 can each extend through the body 40 along a direction that is angularly offset with respect to the first direction L so long as they are extend along a direction that is transverse to the first direction L. As shown, the apertures 56 each define a cylinder. It should be appreciated, however, that the apertures 56 can define any shape as desired so long as the apertures 56 extend through the body 40 so as to provide passageways from outside of the support member 26 through to the channel 44. For example, the apertures can define rectangular shaped slots. The passageways allow light from the fluorescent light source 34 to pass through the body 40 so as to attract the stink bugs toward the support member 26.

As shown in FIGS. 1B and 2, the body 40 is cylindrical in shape, though it should be appreciated that the body 40 can include any shape as desired. The body 40 defines a first or inner dimension, such as a diameter D₁ that is measured with respect to the inner surface 52 of the body 40. The body 40 further defines a second or outer dimension, such as a diameter D₂ that is measured with respect to the outer surface 52 of the body 40. The diameter D₁ can be sufficient to allow a light bulb to extend into the channel 44 of the support member 26.

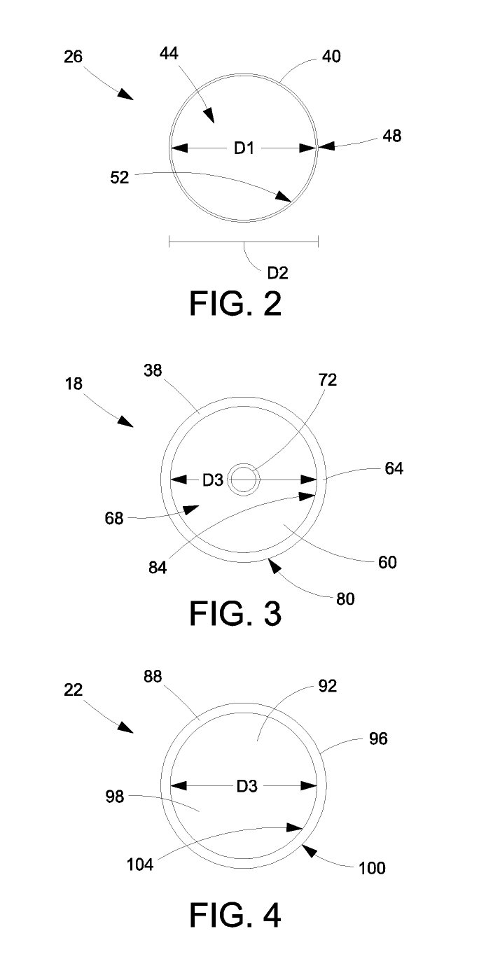

As shown in FIGS. 1B and 3, the first housing 18 defines an upper cap 38 that is coupled to the proximal end P of the support member 26. The first housing 18 can be removeably coupled or permanently coupled to the proximal end P of the support member 26. The first housing 18 includes an outer wall 60 and a sidewall 64 that extends around the outer member 60. The outer wall 60 and the sidewall 64 together define a cavity 68. The first housing 18 further includes a socket 72 that extends from the outer wall 60 and into the cavity 68. The socket 72 can be electrically coupled either directly or indirectly to an electrical source such as a battery, solar panel, power grid, or generator. The socket 72 is configured to receive the fluorescent light source 34 such that the fluorescent light source 34 extends at least partially into the channel 44 of the support member 26. It should be appreciated, however, that the light source can be external to the channel 44 so long as fluorescent light from the fluorescent light source 34 is directed into the channel 44.

The sidewall 64 of the first housing 18 is cylindrical and defines an outer surface 80 and an inner surface 84. It should be appreciated, however, that the side wall 64 may define any shape as desired, so long as the first housing 18 can be coupled to the proximal end of the support member 26. As shown in FIG. 3, the sidewall defines a first or inner dimension, such as diameter D₃ that is measured with respect to the inner surface 84 of the sidewall 64. As shown in FIG. 1B, the diameter D₃ is slightly greater than the outer diameter D₂ of the body 40 of the support member 26 such that the first housing 18 can be coupled to the proximal end P of the support member 26 through an interference fit. It should be appreciated, however, that the first housing 18 may further include a coupling member such as a thread that can engage a thread defined by the support member 26 to thereby couple the first housing 18 to the support member 26.

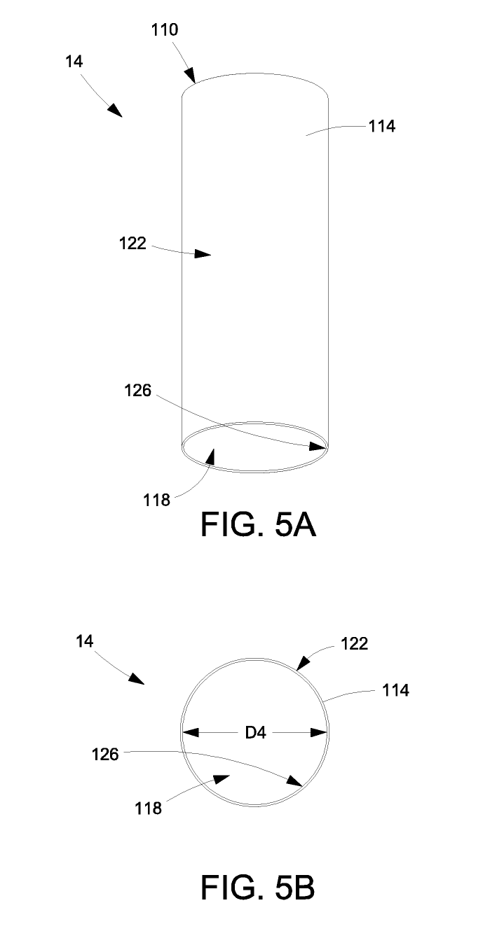

Similar to the first housing 18 and referring to FIG. 4, the second housing 22 defines a lower cap 88 that is coupled to the distal end D of the support member 26. The second housing 22 is removeably coupled the distal end D of the support member 26. The second housing 22 includes an outer wall 92 and a sidewall 96 that extends around the outer wall 92. The outer wall 92 and the sidewall 96 together define a cavity 98. The cavity 98 is configured to receive the distal end D of the support member 26 to thereby releasably couple the second housing 22 to the support member 26.

The sidewall 96 of the second housing 22 is cylindrical and defines an outer surface 100 and an inner surface 104. It should be appreciated, however, that the side wall 96 may define any shape as desired, so long as the second housing 22 can be releasably coupled to the distal end of the support member 26. As shown in FIG. 4, the sidewall 96 defines similar dimensions as the first housing 18. That is, the sidewall 96 of the second housing 22 also defines a first or inner dimension, such as diameter D₃ that is measured with respect to the inner surface 104 of the sidewall 96. As shown in FIG. 1B, the diameter D₃ is slightly greater than the second diameter D₂ of the body 40 of the support member 26 such that the cavity 98 of the second housing 22 can receive the body 40 of the support member 26 to thereby couple the second housing 22 to the distal end D of the support member 26 through an interference fit. It should be appreciated, however, that the second housing 22 may further include a coupling member such as a thread that can engage a thread defined by the support member 26 to thereby couple the second housing 22 to the support member 26.

As shown in FIGS. 1A and 1B, the fluorescent light source 34 can be mounted to the socket 72 of the first housing 18 such that the fluorescent light source 34 extends into the channel 44 of the support member 26 or at least is capable of directly fluorescent light into the channel 44. The fluorescent light source 34 is configured to attract or otherwise lure stink bugs toward the replaceable cartridge 14. Certain flying insects, such as mosquitos are drawn toward ultraviolet (UV) light because they see UV light better than visible light, and because the flower patterns that attract flying insects are revealed in UV light. Unlike these flying insects, however, it has been found that stink bugs are not as attracted to UV light, but are instead more attracted to light sources that filter out UV light such as fluorescent light bulbs. Unlike other lights typically used in bug traps, fluorescent light bulbs filter out a high percentage of UV light leaving behind a high percentage of red, yellow, white, or even green lights. It has been found that stink bugs are more attracted to these lights rather than UV light as with typical flying insects. An example fluorescent light bulb that may be used is 14 Watt, 23 Watt, or 32 Watt standard compact fluorescent light bulb manufactured by TCP, Incorporated having a place of business in Aurora, Ohio. Such light bulbs can have a light temperature of 2700 K. It should be appreciated, however, that the fluorescent light source is not limited to the disclosed example light bulbs.

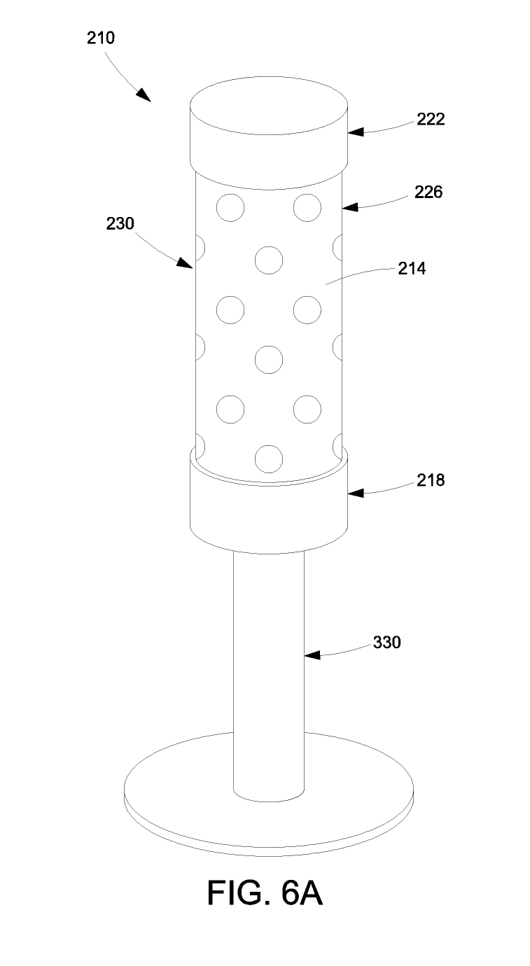

As shown in FIGS. 5A and 5B, the outer surface 48 of the support member 26 can carry an adhesive. As shown, in the illustrated embodiment the replaceable cartridge 14 is configured to be mounted onto the support member 26. In the illustrated embodiment, the replaceable cartridge 14 defines a sleeve 110 and includes a body 114 and a channel 118 that extends through the body 114 along the first direction L. The body 114 defines an outer sticky surface 122 and an inner surface 126 that faces the support member 26 when the replaceable cartridge 14 is disposed on the support member 26. The outer sticky surface 122 is configured to adhere to stink bugs so as to immobilize the stink bugs. The outer sticky surface 122 can include an adhesive or other sticky material that is applied to the body 114 or alternatively is integrally formed with the body 114. For example, the outer sticky surface 122 can include an adhesive that is applied to the body 114 with an application device such as a syringe. It should be appreciated, however, that the outer sticky surface 122 can be made from any substance capable of immobilizing a stink bug. Because the outer surface of the support member carries the replaceable cartridge 14, it can be said that the outer surface of the support member carries the adhesive. It should be appreciated, however, that the support member 26 can have the adhesive applied directly to the outer surface 48 so as to define an outer sticky surface.

As shown in FIG. 5B, the body 114 of the replaceable cartridge 14 can be cylindrical in shape and further defines a first or inner dimension, such as a diameter D₄. The diameter D₄ is slightly greater than the outer diameter D₂ of the support member 26. Therefore, the replaceable cartridge 14 can be placed onto or otherwise slid over the support member 26 and then subsequently removed as desired.

The body 114 of the replaceable cartridge 14 can be substantially flexible. By making the body 114 out of a flexible material, the replaceable cartridge 14 can easily be placed onto the support member 26. It should be appreciated, however, that the body 114 can also be a rigid construct that is pre-formed to fit over the support member 26.

The body 114 of the replaceable cartridge 14 can also be translucent. Therefore, when the replaceable cartridge 14 is placed onto the support member 26, light that is produced by the fluorescent light source 34 will be visible through the replaceable cartridge 14. The body 114 can be made to have a varying degree of translucencies, as desired, so long as the light that is produced by the fluorescent light source 34 is visible through the body 114.

Referring back to FIG. 1B, the stink bug trap 10 can also include a hanging mechanism 130 that extends proximally from the first housing 18. The hanging mechanism 130 can be a hook that is configured to attach to a pre-existing structure to thereby allow the stink bug trap 10 to hang from the structure. It should be appreciated, however, that the hanging mechanism 130 can have any configuration as desired so long as the stink bug trap 10 can hang from a structure. For example, the hanging mechanism 130 can also be a magnet or a suction cup.

In operation, the second housing 22 is removed from the distal end of the support member 26 and a first replaceable cartridge 14 is mounted onto the support member 26. For example, the replaceable cartridge 14 can be removeably disposed about at least a portion of the support member 26 such that the support member 26 is disposed between the directed fluorescent light and the replaceable cartridge 14. Once the first replaceable cartridge 14 is in place the second housing 22 is recoupled to the distal end of the support member 26 to thereby capture the replaceable cartridge 14 onto the support member 26 between the first and second housings 18 and 22. The stink bug trap 10 is then hung on a structure by the hanging mechanism 130 and the fluorescent light source 34 is turned on. Fluorescent light from the fluorescent light source 34 will be directed into the channel 44 such that the fluorescent light passes through the body 40 of the support member 26 or at least through the apertures 56 of the support member 26 and through the body 114 of the replaceable cartridge 14. Therefore, the fluorescent light that is produced by the fluorescent light source 34 is visible to stink bugs through both the support member 26 and the replaceable cartridge 14. The fluorescent light will attract or otherwise lure stink bugs toward the replaceable cartridge 14. When the stink bugs contact the outer sticky surface 122 of the replaceable cartridge 14, the stink bugs will adhere to the replaceable cartridge and thus be immobilized. In other words, the stink bugs will not be able to leave the replaceable cartridge 14 on their own merits. As soon as the first replaceable cartridge 14 is filled or has otherwise immobilized a plurality of stink bugs, the second housing 22 can once again be removed from the support member 26 and the first replaceable cartridge 14 can be slid off so that a second replaceable cartridge 14 can subsequently be mounted onto the support member 26. This process can be repeated as many times as desired.

Now referring to FIGS. 6A and 6B, the stink bug trap can be configured as a table top stink bug trap 210. The table top stink bug trap 210 is substantially similar to the stink bug trap 10 shown in FIG. 1A. Therefore, the stink bug trap 210 includes similar dimensioning and operates in a similar manner as the stink bug trap 10 shown in FIG. 1A. As shown in FIG. 5B, the stink bug trap 210 includes a first housing 218, a second housing 222, a substantially rigid support member 226 that extends between the first and second housings 18 and 22 along a first direction L, and a replaceable cartridge 214. The first housing 218, the second housing 222, and the support member 226 together define a mount 230 that is configured to support the replaceable cartridge 214. The stink bug trap 210 further includes a fluorescent light source 234 that is configured to attract or otherwise lure the stink bugs to the stink bug trap 210 and in particular to the replaceable cartridge 214. In some embodiments, at least one of the first housing 218, the second, housing 222, the support member 226, and the replaceable cartridge 214 can include a stink bug attractant such as a pheromone.

The support member 226 includes a body 240 that is elongate in the first direction L and defines a proximal end P and a distal end D. The support member 26 further includes a cylindrical channel 244 that extends at least partially through the body 240 along the first direction L. In the illustrated embodiment, the channel 244 extends completely through the body 240, though it should be appreciated that the channel 244 can extend only partially through the body 240, as desired. Moreover, the channel 244 can have any shape as desired and is not limited to a cylindrical shape as illustrated. The support member 226 can be made from any material as desired. For example, the support member 226 can be made from a plastic material. Moreover, the support member 226 can be at least translucent so as to allow light from the fluorescent light source 234 to pass through the body 40. It should be appreciated however, that the support member 226 can also be opaque so long as the body 40 includes some structure that allows light from the fluorescent light source 234 to pass through the body 40.

The body 240 has an outer surface 248 and an inner surface 252. The support member 226 includes at least one, such as a plurality of apertures 256 that extend through the body 240 from the outer surface 248 to the inner surface 252. The apertures 256 each extends through the body 240 along a direction that is transverse to the first direction L. In the illustrated embodiment, the apertures 256 each extend through the body 240 along a direction that is perpendicular to the first direction L, though it should be appreciated that the apertures 256 can each extend through the body 240 along a direction that is angularly offset with respect to the first direction L so long as they are extend along a direction that is transverse to the first direction L. As shown, the apertures 256 each define a cylinder. It should be appreciated, however, that the apertures 256 can define any shape as desired so long as the apertures 256 extend through the body 240 so as to provide passageways from outside of the support member 226 through to the channel 244. For example, the apertures 256 can define rectangular shaped slots. The passageways allow light from the fluorescent light source 234 to pass through the body 240 so as to attract the stink bugs toward the support member 226.

The first housing 218 defines a lower cap 238 that is coupled to the distal end D of the support member 226. The first housing 218 can be removeably coupled or permanently coupled to the distal end D of the support member 226. The first housing 218 includes an outer wall 260 and a sidewall 264 that extends around the outer member 260. The outer wall 260 and the sidewall 264 together define a cavity 268. The first housing 218 further includes a socket 272 that extends from the outer wall 260 and into the cavity 268. The socket 272 can be electrically coupled to an electrical source such as a battery, solar panel, power grid, or generator. The socket 272 is configured to receive the fluorescent light source 234 such that the fluorescent light source 234 extends at least partially into the channel 244 of the support member 226. It should be appreciated, however, that the light source can be external to the channel 244 so long as fluorescent light from the fluorescent light source 234 is directed into the channel 244.

Similar to the first housing 218, the second housing 222 defines an upper cap 288 that is coupled to the proximal end P of the support member 226. The second housing 222 is removeably coupled the proximal end P of the support member 226. The second housing 222 includes an outer wall 292 and a sidewall 296 that extends around the outer wall 292. The outer wall 292 and the sidewall 296 together define a cavity 298. The cavity 298 is configured to receive the proximal end P of the support member 226 to thereby releasably couple the second housing 222 to the support member 226.

The fluorescent light source 234 can be mounted to the socket 272 of the first housing 218 such that the fluorescent light source 234 extends into the channel 244 of the support member 226 or at least light from the fluorescent light source 234 is directed into the channel 244. The fluorescent light source 234 is configured to attract or otherwise lure stink bugs toward the cartridge 214. Certain flying insects, such as mosquitos are drawn toward ultraviolet (UV) light because they see UV light better than visible light, and because the flower patterns that attract flying insects are revealed in UV light. Unlike these flying insects, however, it has been found that stink bugs are not as attracted to UV light, but are instead more attracted to light sources that filter out UV light such as fluorescent light bulbs. Unlike other lights typically used in bug traps, fluorescent light bulbs filter out a high percentage of UV light leaving behind a high percentage of red, yellow, white, or even green lights. It has been found that stink bugs are more attracted to these lights rather than UV light as with typical flying insects. TCP

The replaceable cartridge 214 is identical to the replaceable cartridge 14 shown in FIGS. 2A and 2B and is configured to be mounted onto the support member 226 between the first and second housings 218 and 222.

Referring to FIG. 6B, the stink bug trap 210 can also include a base 330 that extends distally from the first housing 218. The base 330 can be a platform that is configured to rest on a pre-existing structure to thereby allow the stink bug trap 210 to sit or otherwise be supported by the structure. It should be appreciated, however, that the base 330 can have any configuration as desired so long as the stink bug trap 210 can be supported by a structure. For example, the base 330 can also be a pole that is inserted into the ground.

In operation, the second housing 222 is removed from the proximal end of the support member 226 and a first replaceable cartridge 214 is mounted onto the support member 226. For example, the replaceable cartridge 214 can be removeably disposed about at least a portion of the support member 226 such that the support member 226 is disposed between the directed fluorescent light and the replaceable cartridge 214. Once the first replaceable cartridge 214 is in place the second housing 222 is recoupled to the proximal end of the support member 226 to thereby capture the replaceable cartridge 214 onto the support member 226 between the first and second housings 218 and 222. The stink bug trap 210 may then be supported on a structure and the fluorescent light source 234 is turned on. Fluorescent light from the fluorescent light source 234 will be directed into the channel 244 such that the fluorescent light passes through the body 240 of the support member 226 or at least through the apertures 256 of the support member 226 and through the body of the replaceable cartridge 214. Therefore, the fluorescent light that is produced by the fluorescent light source 234 is visible to stink bugs through both the support member 226 and the replaceable cartridge 214. The fluorescent light will attract or otherwise lure stink bugs toward the replaceable cartridge 214. When the stink bugs contact the outer sticky surface of the replaceable cartridge 214, the stink bugs will adhere to the replaceable cartridge and thus be immobilized. In other words, the stink bugs will not be able to leave the replaceable cartridge 214 on their own merits. As soon as the first replaceable cartridge 214 is filled or has otherwise immobilized a plurality of stink bugs, the second housing 222 can once again be removed from the support member 226 and the first replaceable cartridge 214 can be slid off so that a second replaceable cartridge 214 can subsequently be mounted onto the support member 226. This process can be repeated as many times as desired.

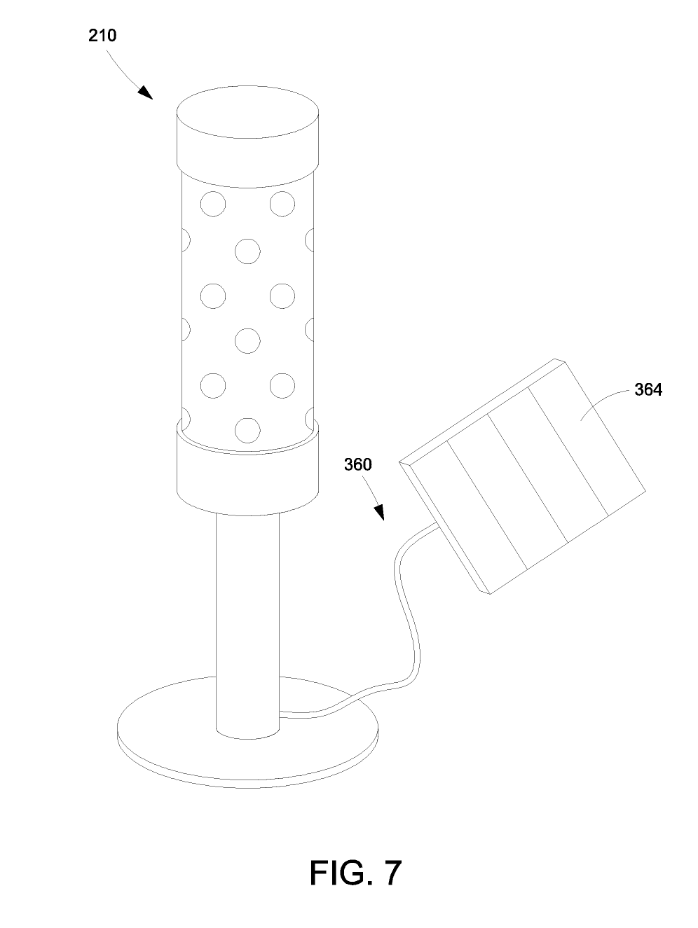

Now referring to FIG. 7, the stink bug traps 10 and 210 can further include a solar panel system 360 that is configured to power the fluorescent light source 34 or 234 respectively. The solar panel system 360 includes a solar panel 364, a battery cell(s) configured to store power produced by the solar panel 364, and a photoelectric dusk to dawn sensor for automatic on/off operation. The solar panel 364 can vary in size, shape, voltage output and mounting position suitable to sustain many variable configurations. For example, the solar panel 364 can be mounted onto the first housing 18 or the first housing 218 depending on the configuration of the stink bug trap. Moreover, the solar panel 364 can be mounted on a structure that is independent to the stink bug trap, as desired.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the present description. For example, it should be appreciated that the support member of the stink bug trap can be the replaceable cartridge. Moreover it should be appreciated that the term stink bug includes all forms of stink bugs such as the brown marmorated stink bug and the kudzu bug, for example. Furthermore, any features of one described embodiment can be applicable to the other embodiments described herein.

What is claimed:

1. A stink bug trap comprising:
a first housing;
a support member that supports the first housing and extends from the first housing along a first direction, the support member including a body, a channel extending at least partially through the body along the first direction, and at least one aperture that extends through the body along a direction that is transverse to the first direction; and
a light source coupled to the first housing such that the light source directs light into the channel of the support member and through the at least one aperture of the support member so as to attract sink bugs toward the support member,
wherein the support member carries an adhesive that is configured to adhere to a stink bug when the stink bug is brought into contact with the adhesive, thereby immobilizing the stink bug.

2. The stink bug trap of claim 1, wherein the light source is a fluorescent light source.

3. The stink bug trap of claim 2, further comprising a replaceable cartridge that is configured to be removeably disposed about at least a portion of the support member such that the support member is disposed between the directed fluorescent light and the cartridge, the replaceable cartridge including a cartridge body that defines an inner surface that faces the support member and an outer surface opposite the inner surface, wherein the outer surface includes the adhesive and the cartridge body is at least translucent so as to transmit at least a portion of the directed light from the inner surface through the outer surface.

4. The stink bug trap of claim 1, wherein the support member includes a plurality of apertures that extend through the body along a direction that is transverse to the first direction.

5. The stink bug trap of claim 4, wherein each aperture of the plurality of apertures defines a cylinder.

6. The stink bug trap of claim 1, further comprising a base that extends from the first housing, the base configured to rest on a structure to thereby support the stink bug trap on the structure.

7. The stink bug trap of claim 1, further comprising a solar panel coupled to the light source.

8. The stink bug trap of claim 1, further comprising a second housing, wherein the support member extends between the first and second housings.

9. The stink bug trap of claim 8, further comprising a hanging mechanism that extends from the first housing, the hanging mechanism is configured to attach to a structure to thereby allow the stink bug trap to hang from the structure.

10. The stink bug trap of claim 8, wherein at least one of the first housing, the support member, and the second housing includes a stink bug attractant.

11. A stink bug trap comprising:
a first housing;
a support member that supports the first housing and extends from the first housing along a first direction, the support member including a body and a channel extending at least partially through the body along the first direction;
a fluorescent light source coupled to the first housing such that the fluorescent light source directs fluorescent light into the channel of the support member so as to attract sink bugs toward the support member; and
a replaceable cartridge that is configured to be removeably disposed about at least a portion of the support member such that the support member is disposed between the directed fluorescent light and the cartridge, the replaceable cartridge including a cartridge body that defines an inner surface that faces the support member and a sticky outer surface opposite the inner surface, wherein the cartridge body is at least translucent so as to transmit at least a portion of the directed light from the inner surface through the sticky outer surface, and the sticky outer surface is configured to adhere to a stink bug when the stink bug is brought into contact with the sticky surface, thereby immobilizing the stink bug.

12. The stink bug trap of claim 11, wherein the support member further includes at least one aperture that extends through the body along a direction that is transverse to the first direction.

13. The stink bug trap of claim 11, further comprising a second housing, wherein the support member extends between the first and second housings and removal of the second housing allows the replaceable cartridge to be removed.

14. The stink bug trap of claim 13, wherein the replaceable cartridge is captured between the first and second housings.

15. The stink bug trap of claim 14, further comprising a hanging mechanism that extends from the first housing, the hanging mechanism is configured to attach to a structure to thereby allow the stink bug trap to hang from the structure.

16. The stink bug trap of claim 13, wherein at least one of the first housing, the support member, the replaceable cartridge, and the second housing includes a stink bug attractant.

17. The stink bug trap of claim 11, wherein the body is a rigid cylindrically shaped body.

18. The stink bug trap of claim 11, wherein the support member includes a plurality of apertures that extend through the body along a direction that is transverse to the first direction.

19. The stink bug trap of claim 11, wherein each aperture of the plurality of apertures defines a cylinder.

20. The stink bug trap of claim 11, wherein the fluorescent light source extends from the first housing into the channel

21. The stink bug trap of claim 11, wherein the replaceable cartridge is at least partially supported by the first housing

22. The stink bug trap of claim 11, further comprising a base that extends from the first housing, the base configured to rest on a structure to thereby support the stink bug trap on the structure.

23. The stink bug trap of claim 11, further comprising a solar panel coupled to the fluorescent light source.

24. The stink bug trap of claim 11, wherein the replaceable cartridge is a flexible sleeve.

25. The stink bug trap of claim 11, wherein the replaceable cartridge includes an adhesive layer that defines the outer sticky surface.

26. A replaceable cartridge configured to be placed on a cylindrical rigid support member of a stink bug trap between first and second housings so as to be captured between the first and second housings, the replaceable cartridge comprising:
a cylindrical translucent body that is elongate in a first direction, the body including an inner surface that faces the support member when the replaceable cartridge is placed on the support member, and a sticky outer surface opposite the inner surface, the inner surface defining a channel that extends through the body along the first direction, and the sticky outer surface is configured to adhere to a stink bug when the stink bug is brought into contact with the sticky surface, thereby immobilizing the stink bug,
wherein at least a portion of the body is configured to be mounted on the rigid support member of the stink bug trap such that the channel at least partially receives a fluorescent light bulb and light produced by the fluorescent light bulb is visible through the body to thereby attract stink bugs to the outer sticky surface of the body.

27. The replaceable cartridge of claim 26, wherein the body defines a flexible sleeve.

28. A method of immobilizing stink bugs, the method comprising:
placing a replaceable cartridge onto a rigid member, the replaceable cartridge defining a sticky outer surface that is configured to adhere to stink bugs to thereby immobilize the stink bugs;
luring stink bugs to the removable cartridge with a fluorescent light source;
immobilizing the stink bugs when the stink bugs contact the sticky surface of the replaceable cartridge; and
removing the replaceable cartridge from the rigid member after the removable cartridge has immobilized a plurality of stink bugs.

29. The method of claim 28, wherein the step of luring the stink bugs comprises allowing light from the fluorescent light source to pass through the replaceable cartridge.

30. The method of claim 29, wherein the step of luring the stink bugs further comprises allowing the light from the fluorescent light source to pass through the rigid member.
